(19) United States
(12) Patent Application Publication
(10) Pub. No.: US 2025/0379699 A1
(43) Pub. Date: Dec. 11, 2025

(54) CSI REPORTING METHOD AND DEVICE IN WIRELESS COMMUNICATION SYSTEM

(71) Applicant: Samsung Electronics Co., Ltd., Suwon-si (KR)

(72) Inventors: Hyun jae PARK, Suwon-si (KR); Yookeun KANG, Suwon-si (KR); Seunghun YU, Suwon-si (KR); Ki-Ho KIL, Suwon-si (KR)

(73) Assignee: Samsung Electronics Co., Ltd., Suwon-si (KR)

(21) Appl. No.: 19/228,208

(22) Filed: Jun. 4, 2025

(30) Foreign Application Priority Data
Jun. 10, 2024 (KR) 10-2024-0075244

(51) Int. Cl. H04L 5/00; H04B 7/06; H04B 17/309; H04B 17/318

(52) U.S. Cl. CPC H04L 5/0051; H04B 7/0617; H04B 7/0626; H04B 17/328; H04B 17/346

(57) ABSTRACT

A method performed by user equipment in a wireless communication system includes receiving a tracking reference signal (TRS) from a base station and reporting at least one of reference signal received power (RSRP) or signal-to-interference-plus-noise ratio (SINR), obtained based on the TRS, to the base station.

### CROSS-REFERENCE TO RELATED APPLICATION(S)

This application is based on and claims priority under 35 USC § 119 to Korean Patent Application No. 10-2024-0075244, filed on Jun. 10, 2024, in the Korean Intellectual Property Office, the disclosure of which is herein incorporated by reference in its entirety.

### BACKGROUND

### 1. Field

The disclosure relates to a device and a method for reporting channel state information (CSI) in a wireless communication system.

### 2. Description of Related Art

In 5^{th} generation (5G) new-radio (NR) mobile communication technology, wide frequency bands to achieve a high data transmission rate and enable new services are defined. In addition, the 5G NR mobile communication technology may be implemented not only in sub-6 GHZ bands such as 3.5 GHZ, but also in ultrahigh-frequency bands (above 6 GHz), known as millimeter wave (mmWave) bands such as 28 GHz and 39 GHz.

In a new-radio (NR) system, a user equipment may efficiently manage downlink (DL) resources and antenna operations using the channel estimation parameters estimated for a channel. A channel state information reference signal (CSI-RS) and a synchronization signal block (SSB) may be supported for the user equipment to perform channel estimation and reporting.

### SUMMARY

One or more aspects of the disclosure provide a device and a method for reporting CSI in a wireless communication system using a tracking reference signal (TRS).

According to an aspect of the disclosure, there is provided a method performed by a user equipment in a wireless communication system, the method including: receiving a tracking reference signal (TRS) from a base station; and reporting, to the base station, at least one of reference signal received power (RSRP) and signal-to-interference-plus-noise ratio (SINR), obtained based on the TRS.

According to another aspect of the disclosure, there is provided a method performed by a base station in a wireless communication system, the method including: transmitting a tracking reference signal (TRS) to a user equipment; and receiving, from the user equipment, at least one of reference signals received power (RSRP) and signal-to-interference-plus-noise ratio (SINR) obtained based on the TRS.

According to another aspect of the disclosure, there is provided a wireless communication system including: one or more transceivers: one or more processors electrically connected to the one or more transceivers; and one or more memories electrically connected to the one or more processors and configured to store at least one instruction, wherein, when executed by the at least one processor, the at least one instruction is configured to control the device to: receive a tracking reference signal (TRS) from a base station through the transceiver; and report, to the base station, at least one of reference signals received power (RSRP) and signal-to-interference-plus-noise ratio (SINR) obtained based on the TRS.

### BRIEF DESCRIPTION OF DRAWINGS

FIG. 1 is a diagram illustrating a wireless communication system according to one or more example embodiments.

FIG. 2 is a diagram illustrating a resource grid in a wireless communication system according to one or more example embodiments.

FIG. 3 is a diagram illustrating a structure of a synchronization signal block (SSB) in a wireless communication system according to one or more example embodiments.

FIG. 4 is a diagram illustrating a resource element (RE) pattern of a tracking reference signal (TRS) according to one or more example embodiments.

FIG. 5 is a flowchart of a CSI-related procedure according to one or more example embodiments.

FIG. 6 is a flowchart illustrating a method of user equipment according to one or more example embodiments.

FIG. 7 is a flowchart illustrating a method of a base station according to one or more example embodiments.

FIG. 8 is a flowchart illustrating a reporting method of user equipment according to one or more example embodiments.

FIGS. 9A and 9B are diagrams illustrating a downlink (DL) beam management (BM) operation according to one or more example embodiments.

FIG. 10 is a flowchart illustrating a procedure related to DL beam management according to one or more example embodiments.

FIG. 11 is a diagram illustrating a CSI framework according to one or more example embodiments.

FIG. 12 is a flowchart illustrating a method of operating a device according to one or more example embodiments.

FIG. 13 is a flowchart illustrating a method of operating a device according to one or more example embodiments.

FIG. 14 is a block diagram of a device according to one or more example embodiments.

FIG. 15 is a block diagram of a device according to one or more example embodiments.

### DETAILED DESCRIPTION

Hereinafter, example embodiments will be described with reference to the accompanying drawings. As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

In the following, example embodiments will be described based on an NR network-based wireless communication system, for example, 3^{rd} Generation Partnership Project (3GPP) Release. However, example embodiments are not limited to the NR network, and may be applied to other wireless communication systems, including cellular systems such as long term evolution (LTE), LTE-advanced (LTE-A), wireless broadband (WiBro), global system for mobile communication (GSM), and next-generation communications such as 6G, as well as short-range communication systems such as Bluetooth and near field communication (NFC).

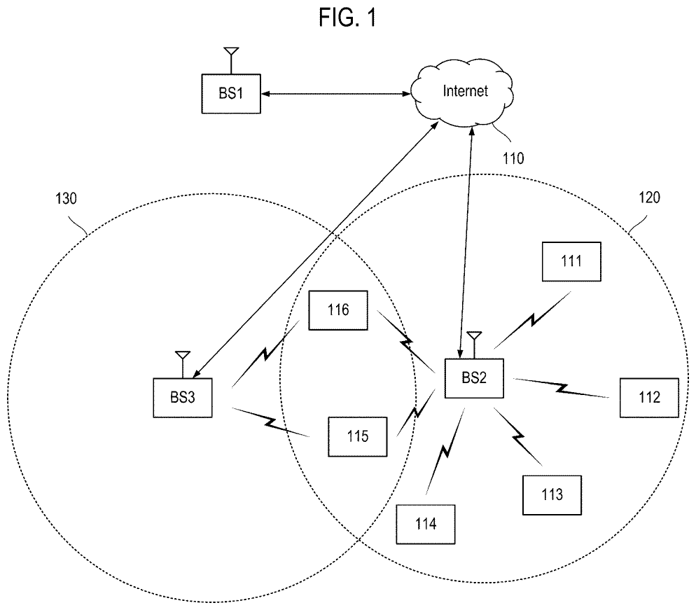

FIG. 1 is a diagram illustrating a wireless communication system according to one or more example embodiments.

Referring to FIG. 1, the wireless communication system may include, but is not limited to, a first base station BS1, a second base station BS2, and a third base station BS3. The first base station BS1 may communicate with the second base station BS2 and the third base station BS3. In addition, the first base station BS1 may communicate with at least one network 110. For example, the network 110 may include, but is not limited to, the Internet, a dedicated Internet Protocol (IP) network, or another data network.

The second base station BS2 may provide a wireless broadband access to the network 110 for a first plurality of user equipments disposed within a coverage area 120 of the second base station BS2. The first plurality of user equipments may include, but is not limited to, a first user equipment 111, a second user equipment 112, a third user equipment 113, a fourth user equipment 114, a fifth user equipment 115, and a sixth user equipment 116.

The first user equipment 111 that may be located in a small and medium-sized enterprise, the second user equipment 112 may be located in a large enterprise, the third user equipment 113 may be located in a Wi-Fi hotspot, the fourth user equipment 114 may be located in a first residential area, the fifth user equipment 115 may be located in a second residential area, and the sixth user equipment 116 may be a mobile device such as a mobile phone, a wireless laptop computer, or a wireless personal digital assistant (PDA). The third base station BS3 may provide a wireless broadband access to the network 110 for a second plurality of user equipments located within a coverage area 130 of the third base station BS3. The second plurality of user equipments may include user equipment 115 and user equipment 116. In some embodiments, one or more of the base stations BS1, BS2 and BS3 may communicate with each other and with the user equipments 111 to 116 using 6G, 5G, LTE, LTE-A, WiMAX, Wi-Fi, or other wireless communication technologies.

According to various embodiments, depending on the type of the network, the terms “base station” or “BS” may refer to a component (or a set of components) configured to provide a wireless access to a network, such as a transmission point (TP), a transmission reception point (TRP), an enhanced (eNodeB or eNB), a 5G base station (gNB), a macrocell, a femtocell, a Wi-Fi access point (AP), or other wireless-enabled devices. The base station may provide a wireless access based on one or more wireless communication protocols, such as radio interface/access NR of 6G or 5G, LTE, LTE-A, high speed packet access (HSPA), Wi-Fi 802.11a/b/g/n/ac, or the like. For ease of description, the terms “base station BS” and “TRP” are interchangeably used herein to refer to network infrastructure that provides a wireless access to a remote terminal.

According to various embodiments, depending on the network type, the terms “terminal” and “user equipment (UE)” may refer to any component such as a “mobile station,” “subscriber station,” “remote terminal,” “wireless terminal,” “receiving point,” or “user device.” For ease of description, the terms “terminal” and “user equipment” are used herein to refer to remote wireless equipment that wirelessly accesses a BS, regardless of whether the user equipment is a mobile device (for example, a mobile phone or a smartphone) or a generally considered stationary device (for example, a desktop computer or vending machine).

In FIG. 1, dashed lines indicate approximate ranges of the coverage areas 120 and 130 represented by approximate circular shapes for illustrative and explanatory purposes only. It will be clearly understood that coverage areas associated with base stations, such as the coverage areas 120 and 130, may have other shapes including irregular shapes depending on the configuration of the base stations and changes in the radio environment related to natural and artificial obstacles.

As will be described in more detail below, in some embodiments, one or more of the first to sixth user equipments 111 to 116 may include circuitry, software code, programming, or a combination thereof for implementing CSI measurement and reporting method and device based on a tracking reference signal (TRS). Also, in some embodiments, one or more of the base stations BS1 to BS3 includes circuitry, programming, or a combination thereof for CSI measurement and reporting method and device based on a TRS in a wireless communication system.

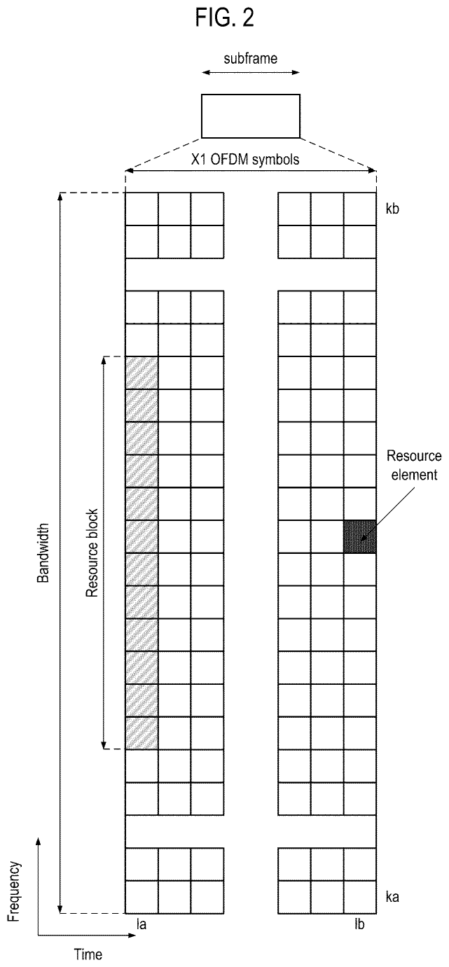

FIG. 2 is a diagram illustrating a resource grid in a wireless communication system according to one or more example embodiments.

Referring to FIG. 2, a basic unit of resource in time and frequency domains is a resource element RE. The resource element RE may be defined as a single orthogonal frequency division multiplexing (OFDM) symbol on a time axis and a single subcarrier (sc) on a frequency axis. In the frequency domain,

$${N}_{sc}^{RB}$$

consecutive OFDM symbols may constitute a single resource block RB, where N is an integer. Also, X1 (where

$$X 1 = {N}_{symb}^{slot} )$$

consecutive OFDM symbols in the time domain may constitute a single subframe.

For a single subframe, a time domain index la of a first OFDM symbol is 0 and a time domain index lb of the last OFDM symbol is 14·2^{μ}−1 (where μ is a subcarrier spacing setting value). For a single bandwidth, a frequency domain index ka of a first RE is 0 and a frequency domain index kb of a last RE is

$${N}_{grid , x}^{size , μ} {N}_{sc}^{RB} - 1$$

(where

$${N}_{grid , c}^{size , μ} {N}_{sc}^{RB}$$

is a size of a carrier bandwidth for a subscript x and μ).

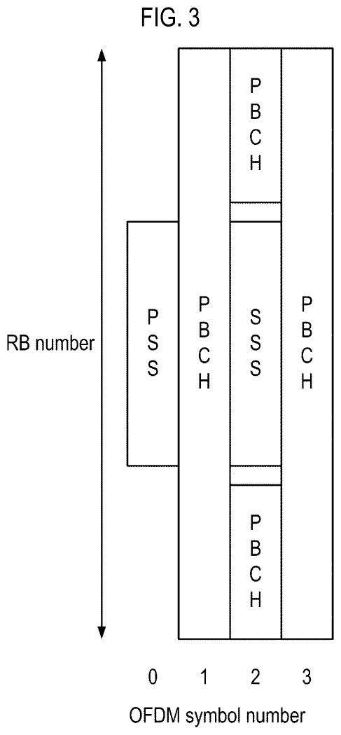

FIG. 3 is a diagram illustrating a synchronization signal block (SSB) structure in a wireless communication system according to one or more example embodiments. However, the SSB structure illustrated in FIG. 3 is only an example, and the scope of the disclosure is not limited thereto.

According to an embodiment, based on the SSB, a user equipment may perform cell search, system information acquisition, beam alignment for initial access, and downlink (DL) measurement. According to an embodiment of the disclosure, SSB may also be referred to as a synchronization signal/physical broadcast channel (SS/PBCHSS/PBCH) block or an SS/PBCH block.

Referring to FIG. 3, an SSB may include a primary synchronization signal PSS, a secondary synchronization signal SSS, and a physical broadcast channel PBCH. Each of the signals PSS and SSS occupies a single OFDM symbol and a plurality of subcarriers, and PBCH spans across three OFDM symbols and the plurality of subcarriers although a single symbol may have a middle portion that is not used for SSS. In a new-radio (NR) network, the number of RBs of the SSB may be set to 20 (for example, 240 subcarriers).

The PSS may serve as a reference signal for DL time/frequency synchronization and provide partial information of cell ID. The SSS may also serve as a reference signal for DL time/frequency synchronization and provide ID information of the remaining cells that is not provided by the PSS. In addition, the SSS may serve as a reference signal for demodulating the PBCH. The PBCH may carry a master information block MIB.

Polar coding may be used for the PBCH. The PBCH may internally carry a frequency-multiplexed demodulation reference signal DMRS, known as PBCH-DMRS.

In an example case in which user equipment is powered on or newly enters a cell, the user equipment may perform an initial cell search process. For example, the user equipment may perform synchronization with a base station. During the initial cell search process, the user equipment may receive the signals PSS and SSS to be synchronized with the base station and obtain information such as cell ID. Then, the user equipment may receive the PBCH from the base station and obtain MIB from the PBCH. The user equipment may receive a control resource set CORESET for receiving system information (which may correspond to remaining system information RMS or system information block 1 SIBI1) required for initial access, as well as configuration information on the control resource set CORESET and search space from the MIB. Each of the control resource set CORESET and the search space, configured as the MIB, may be considered to correspond to an identity ID of 0.

The user equipment may monitor a control resource set #0 CORESET #0 in the case in which DMRS transmitted in a selected SSB and the CORESET #0 is quasi-co-located (QCLed). The user equipment may receive SIB1 from the downlink control information transmitted in the CORESET #0. In terms of QCL, when properties (or large-scale properties) of the channel, through which a symbol on one antenna port is carried, may be inferred from the channel through which a symbol on another antenna port is carried, two antennas may be considered to be in a QCL relationship. For example, the large-scale properties may include one or more of delay spread, Doppler spread, Doppler shift, average gain, average delay, and spatial Rx parameters.

The user equipment may obtain configuration information related to a random access channel RACH, required for initial connection, from the received SIB1. The user equipment may perform a random access procedure based on the configuration information related to RACH.

In the time domain, the SSB may include four OFDM symbols, and the PSS, SSS, PBCH, and PBCH-DMRS may be mapped to the symbols as illustrated in Table 1.

TABLE 1

| Channel | OFDM symbol number/ | Subcarrier number k |
|---|---|---|
| or | relative to the start | relative to the start |
| signal | of an SS/PBCH block | of an SS/PBCH block |
| PSS | 0 | 56, 57, . . . 182 |
| SSS | 2 | 56, 57, . . . , 182 |
| Set to 0 | 0 | 0, 1, . . . , 55, 183, |
| | | 184, . . . , 239 |
| | 2 | 48, 49, . . . , 55, 183, |
| | | 184, . . . , 191 |
| PBCH | 1, 3 | 0, 1, . . . , 239 |
| | 2 | 0, 1, . . . , 47, |
| | | 192, 193, . . . , 239 |
| DM-RS | 1, 3 | 0 + v, 4 + v, 8 + v, . . . , 236 + v |
| for | 2 | 0 + v, 4 + v, 8 + v, . . . , 44 + v |
| PBCH | | 192 + v, 196 + v, . . . , 236 + v |

Referring to Table 1, PBCH-DMRS may have a mapping pattern varying depending on a variable ‘v.’ However, in a first symbol and a third symbol, PBCH-DMRS may be commonly mapped every four subscriber intervals on a frequency. The variable ‘v’ is defined as

$${N}_{ID}^{cell}$$

mod 4 (where

$${N}_{ID}^{cell}$$

is a physical cell ID). The variable ‘v’ is determined by taking a modulo-4 operation of the physical cell ID, so that the mapping pattern may vary depending on the physical cell ID.

In a new-radio (NR) network, the above-described SSB may be used for channel measurement along with a channel state information reference signal (CSI-RS).

CSI-RS is a reference signal for channel state information (CSI) reporting of user equipment. CSI-RS may be used for time/frequency tracking, a Layer 1-Reference Signal Receiving Power (L1-RSRP) computation, Layer 1-Signal to Interference plus Noise Ratio (L1-SINR) computation, mobility, and fast activation of secondary cell (SCell) tracking. Channel state information CSI refers to information that may indicate the quality of a wireless channel (or link) formed between user equipment and an antenna port.

In the NR network, a tracking reference signal (TRS) is supported to track time/frequency of a device. TRS may be referred to as other terms such as “CSI-RS for tracking” in the standard, but will be used as it is for ease of description. TRS refers to non-zero power (NZP) CSI-RS in which a repetition parameter, a higher-layer parameter, of CSI-RS is not set and trs-Info is set to true.

According to an embodiment, the CSI-RS may be used as TRS when repetition is not set and trs-Info is set, the CSI-RS may be used for beam management when repetition is set and trs-Info is set, and the CSI-RS may be used for CSI acquisition when neither repetition nor trs-Info is set.

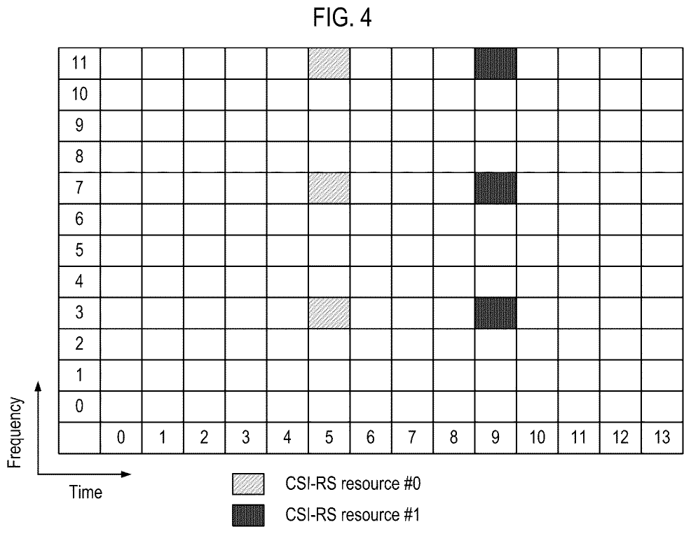

FIG. 4 is a diagram illustrating an RE pattern of a TRS.

Referring to FIG. 4, TRS may be mapped to a plurality of single-port CSI-RS resources having a frequency RE density of 3 REs per 1 RB. Two single-port CSI-RS may be included in a single slot. For example, in a frequency band below 6 GHz defined as FR1, TRS may be transmitted over two consecutive slots, and a symbol pair in which the CSI-RS resources may be located within each slot may be one of {5^{th}, 9^{th}}, {6^{th}, 10^{th}}, or {7^{th}, 11^{th}}. For example, a single TRS transmission may include four CSI-RS resources over two consecutive slots.

According to another embodiment, in a frequency band above 6 GHz defined as FR2, two or four CSI-RS resources may be provided. In FR2, a symbol pair that is able to be located in a single slot may be one of {1^{st}, 5^{th}}, {2^{nd}, 6^{th}}, {3^{rd}, 7^{th}}, {4^{th}, 8^{th}}, {5^{th}, 9^{th}}, {6^{th}, 10^{th}}, {7^{th}, 11^{th}}, {8^{th}, 12^{th}}, {9^{th}, 13^{th}}, or {10^{th}, 14^{th}}. For example, CSI-RS resource #0 may be located in the 6^{th} symbol and CSI-RS resource #1 may be located in the 10^{th} symbol, as illustrated in FIG. 4. However, the symbol location in FIG. 4 is only an example of TRS resource mapping, and may vary depending on base station transmission.

The number of RBs allocated to the TRS may be set by a higher-layer parameter nrofRBs, and the allocated RBs may be set from a minimum of 24 to a maximum of 276. Compared to SSB to which 20 RBs are allocated, the number of REs allocated per RB is the same but the total number of RBs is larger for TRS. For example, TRS may receive allocation of more resources over a wider bandwidth than SSB. In addition, TRS may have a higher inverse fast Fourier transform (IFFT) resolution than other reference signals. Accordingly, TRS may be more appropriate to estimate properties that are more appropriate for an actual channel than SSB.

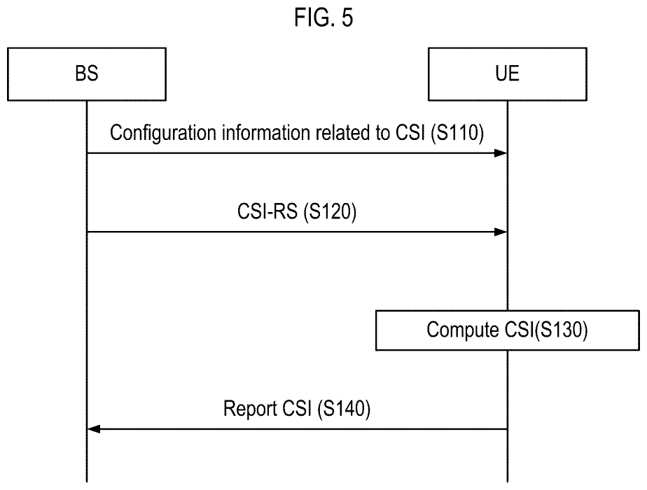

FIG. 5 is a flowchart illustrating a procedure related to CSI according to one or more example embodiments.

Referring to FIG. 5, in operation S110, user equipment may receive CSI-related configuration information from a base station. For example, the user equipment may receive the CSI-related configuration information through radio resource control (RRC) signaling. For example, the CSI-related configuration information may include, but is not limited to, at least one of CSI measurement-related information on resource set allocation and release, CSI reporting-related information on report setting, CSI resource setting-related information on resource setting, CSI-IM interference management resource-related information, CSI measurement configuration-related information, CSI resource configuration-related information, and resource-related information related to various CSI-RS resources.

In operation S120, the user equipment may measure CSI based on the configured CSI-related configuration information received from the base station. Operation S120 may include a first operation, in which the user equipment receives CSI-RS from the base station, and a second operation in which the user equipment calculates CSI based on the received CSI-RS.

In operation S130, the user equipment may report the CSI to the base station. For example, the user equipment may report the CSI, measured based on the received CSI-RS in operation S120, to the base station.

According to an embodiment, the NR network may include a CSI Framework for base station to instruct CSI Measurement and Reporting by the user equipment. The CSI framework of the NR network may include at least report setting and resource setting, and the report setting may reference an ID of the resource setting to establish a connection relationship with the resource setting.

In aperiodic CSI reporting procedures, CSI reporting is assumed to be triggered by DCI format 0_1, but may also be assumed to be triggered by DCI format 0_2 by applying a higher-layer parameter reportTriggerSizeDCI-0-2 rather than reportTriggerSize.

For CSI reporting, the base station may control the time and frequency resources that may be used by the user equipment (UE).

According to one or more example embodiments, the CSI may include, but is not limited to, at least one of channel quality indicator (CQI), precoding matrix indicator (PMI), CSI-RS resource indicator (CRI), SS/PBCH block resource indicator (SSBRI), layer indicator (LI), rank indicator (RI), L1-RSRP, or L1-SINR.

According to one or more example embodiments, the CSI may further include TRS resource indicator (TRSRI). For example, similarly to CRI indicating the CSI-RS resource related to a candidate beam or SSBRI indicating the SS/PBCH block related to a candidate beam, TRSRI may indicate a resource of TRS related to a candidate beam. For example, TRSRI according to one or more example embodiments may be defined as a resource index of TRS, which is a DL RS, similarly to CRI and SSBRI.

For CQI, PMI, CRI, SSBRI, LI, RI, L1-RSRP, L1-SINR, and TRSRI, the user equipment may be configured by a higher layer with N≥1 CSI-ReportConfig report settings, M≥1 CSI-ResourceConfig resource settings, and a list of one or two trigger states (provided by CSI-aperiodicTriggerStateList and CSI-semiPersistentOnPUSCH-TriggerStateList).

Each trigger state of CSI-AperiodicTriggerStateList may include a list associated with CSI-ReportConfigs indicating resource set identifiers (IDs) for the channel and optionally for interference. Each trigger state of CSI-SemiPersistentOnPUSCH-TriggerStateList may include a single associated CSI-ReportConfig.

Hereinafter, a description will be provided for CSI-related configuration information that may be set to the user equipment from the base station through operation S110 of FIG. 5.

According to one or more example embodiments, the report setting may include information related to CSI reporting configuration of the user equipment. The base station may configure the report setting for the user equipment through RRC signaling. The base station may transmit signaling information CSI-ReportConfig to the user equipment to configure the report setting. The report setting may reference an ID of the resource setting.

According to one or more example embodiments, CSI-ReportConfig may include information on each report setting and may be used to configure periodic or semi-persistent reporting transmitted over a physical uplink control channel (PUCCH) in a cell including CSI-ReportConfig, or to configure semi-persistent or aperiodic reporting transmitted over a physical uplink shared channel (PUSCH) triggered by a downlink control indicator (DCI) received in a cell including CSI-ReportConfig (a cell, to which CSI is reported, may be determined by the received DCI).

Each CSI-ReportConfig may be associated with a single downlink bandwidth part (indicated by a higher-layer parameter BWP-Id) given in the associated CSI-ResourceConfig for channel estimation, and may include parameters for a single CSI reporting band. The parameters may include codebook settings including codebook subset restriction, time-domain behavior, frequency granularity for CQI and PMI, measurement restriction settings, and CSI-related quantity to be reported by user equipment such as LI, L1-RSRP, L1-SINR, CRI, or SSBRI. The CSI-related quantity may indicate what type of report information (for example, one or more of CQI, PMI, CRI, SSBRI, LI, RI, L1-RSRP, L1-SINR, and L1-RSRQ) is reported.

The CSI-related quantity may be set by CSI-ReportConfig, as illustrated in Table 2. According to one or more example embodiments, reportQuantity may additionally include TRS-related parameters trs-Index-RSRP and trs-Index-SINR.

TABLE 2
CSI-ReportConfig information element

```
-- ASN1START
-- TAG-CSI-RESOURCECONFIG-START
CSI-ReportConfig ::= SEQUENCE {
  reportQuantity CHOICE {
    ...
      cri-RSRP NULL,
      ssb-Index-RSRP NULL,
    ...
      trs-Index-RSRP NULL,
      trs-Index-SINR NULL
},
-- TAG-CSI-RESOURCECONFIG-STOP
-- ASN1STOP
```

In Table 2, the TRS index indicates an index value of an arbitrary TRS resource set. By configuring reportQuantity having TRS-related parameters trs-Index-RSRP and trs-Index-SINR to user equipment through RRC signaling, the base station may request the user equipment to report CSI having trs-Index-RSRP and trs-Index-SINR. The trs-Index-RSRP may be reported by the user equipment in the form of index values for L1-RSRP reporting, and the trs-Index-SINR may be reported by the user equipment in the form of index values for L1-SINR reporting.

In an example case in which the trs-Index-RSRP is configured, the user equipment may index each TRS based on received RSRP strength of the TRSs. In an example case in which the trs-Index-SINR is configured, the user equipment may index each TRS based on received SINR strength of the TRSs.

According to one or more example embodiments, the resource setting may include information related to a reference signal for the user equipment to measure CSI. The base station may configure resource settings for the user equipment through RRC signaling. The base station may transmit signaling information CSI-ResourceConfig to the user equipment to configure the resource setting. CSI-ResourceConfig may include information on each resource setting.

Each resource setting may be referenced by the report setting.

CSI-ResourceConfig may define one or more NZP-CSI-RS-ResourceSet, CSI-IM-ResourceSet, and/or CSI-SSB-ResourceSet. According to one or more example embodiments, CSI-ResourceConfig may additionally define CSI-TRS-ResourceSet, as illustrated in Table 3.

TABLE 3
CSI-ResourceConfig information element

```
-- ASN1START
-- TAG-CSI-RESOURCECONFIG-START
CSI-ResourceConfig ::= SEQUENCE {
  csi-ResourceConfigId CSI-ResourceConfigId,
  csi-RS-ResourceSetList CHOICE {
    nzp-CSI-RS-SSB SEQUENCE {
      nzp-CSI-RS-ResourceSetList SEQUENCE (SIZE
      (1..maxNrofNZP-
CSI-RS-ResourceSetsPerConfig)) OF NZP-CSI-RS-ResourceSetId
```

OPTIONAL, -- Need R

```
      csi-SSB-ResourceSetList SEQUENCE (SIZE
      (1..maxNrofCSI-SSB-
ResourceSetsPerConfig)) OF CSI-SSB-ResourceSetId
```

OPTIONAL -- Need R

```
      csi-TRS-ResourceSetList SEQUENCE (SIZE
      (1..maxNrofCSI-TRS-
ResourceSetsPerConfig)) OF CSI-TRS-ResourceSetId
```

OPTIONAL -- Need R

```
    },
    csi-IM-ResourceSetList SEQUENCE (SIZE (1..maxNrofCSI-IM-
ResourceSetsPerConfig)) OF CSI-IM-ResourceSetId
  },
  bwp-Id BWP-Id,
  resourceType ENUMERATED { aperiodic, semiPersistent, periodic },
...
}
-- TAG-CSI-RESOURCECONFIG-STOP
-- ASN1STOP
```

Referring to Table 3, each CSI resource setting, CSI-ResourceConfig, may include S(≥1) CSI resource sets (given by the higher-layer parameter csi-RS-ResourceSetList). The list may include references to NZP-CSI-RS resource set(s) and/or SS/PBCH block, or references to CSI-IM resource set(s). For example, the list may define NZP-CSI-RS, SS/PBCH, and/or CSI-IM resources to be used for measurement and reporting.

For example, the nzp-CSI-RS-ResourceSetList may define a list of references to NZP-CSI-RS resources used for beam measurement and reporting in the CSI-RS resource set. The csi-SSB-ResourceSetList may define a list of references to SSB resources used for CSI measurement and reporting in the CSI-RS resource set. The csi-IM-ResourceSetList may define a list of references to CSI-IM resources used for CSI measurement and reporting in the CSI-RS resource set.

According to one or more example embodiments, the list may include references to TRS resource sets. The corresponding list may be set by the higher-layer parameter csi-TRS-ResourceSetList. The csi-TRS-ResourceSetList may define a list of references to TRS resources used for beam measurement and reporting in the CSI-RS resource set.

For example, the user equipment may additionally receive a configuration of TRS resources to be used for beam measurement and reporting in the CSI-RS resource set through the csi-TRS-ResourceSetList.

According to signaling information, each resource setting may include at least one of the resource setting index csi-ResourceConfigId, BWP index bwp-Id, and time-axis transmission setting resourceType of the resource, in addition to a resource set list for defining the above-mentioned resource sets.

The resource setting index csi-ResourceConfigId may be used to identify the CSI resource setting CSI-ResourceConfIG. The resource setting index may be referenced through the report setting.

Each CSI resource setting may be located in a DL BWP identified by the higher-layer parameter bwp-Id. The CSI resource setting may be linked to the CSI reporting setting of the same DL BWP.

Time-axis transmission of the resource may be configured as aperiodic transmission, semi-persistent transmission, or periodic transmission. For periodic or semi-persistent CSI resource settings, the number of CSI-RS resource sets may be limited to S=1, and the configured period and slot offset may be given in numerology of the DL BWP identified by bwp-Id.

For the NZP-CSI-RS resource set included in CSI-ResourceConfig, the base station may be configured with the NZP-CSI-RS-ResourceSet to the user equipment including parameters in Table 4.

TABLE 4
NZP-CSI-RS-ResourceSet information element

-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE |
| (1..maxNrofNZP-CSI-RS-ResourcesPerSet)) | OF NZP-CSI-RS-ResourceId, |
| repetition | ENUMERATED { on, off } |
| aperiodicTriggeringOffset | INTEGER(0..6) |
| trs-Info | ENUMERATED {true} |

...,
}
-- TAG-NZP-CSI-RS-RESOURCESET-STOP
-- ASN1STOP

As illustrated in Table 4, parameters indicating the purpose of CSI-RS may be configured for each NZP-CSI-RS resource set through NZP-CSI-RS-ResourceSet. Repetition is a parameter representing whether the same beam is repeatedly transmitted, and indicates whether repetition is ‘ON’ or ‘OFF’ for each NZP-CSI-RS resource set. The trs-Info indicates that the antenna ports for all NZP-CSI-RS resources within the NZP-CSI-RS resource set are the same. In an example case in which the trs-Info field is empty or released, the user equipment may apply a false value to the field. As descried above, an NZP-CSI-RS resource set in which the repetition parameter is not set and trs-Info is set to true may be defined as TRS.

According to one or more example embodiments, the base station may configure the higher-layer parameter CSI-TRS-ResourceSet, as specified in Table 5 below, for the user equipment to configure the TRS resources to be used for beam measurement and reporting. CSI-TRS-ResourceSet may be used to configure a TRS block resource set referencing CSI-RS for tracking.

TABLE 5
CSI-TRS-ResourceSet information element

```
-- ASN1START
-- TAG-CSI-TRS-RESOURCESET-START
CSI-TRS-ResourceSet ::= SEQUENCE {
  csi-TRS-ResourceSetId CSI-TRS-ResourceSetId,
  csi-TRS-ResourceList SEQUENCE (SIZE(1..maxNrofCSI-TRS-
ResourcePerSet)) OF TRS-Index,
  ...
}
-- TAG-CSI-TRS-RESOURCESET-STOP
-- ASN1STOP
```

Referring to Table 5, the CSI-TRS-ResourceSetId and the csi-TRS-ResourceSetList are defined. The CSI-TRS-ResourceSetId may be used to identify a TRS resource set, and the csi-TRS-ResourceList may define a list of TRS resources in the TRS resource set corresponding to the TRS index TRS-Index. The csi-TRS-ResourceList may have a value according to the maximum number of TRS resources supported by NR per resource set maxNrofCSI-TRS-ResourcePerSet.

As a result, through CSI-TRS-ResourceSet, the base station may be configured with the TRS resource set to be used for channel estimation to the user equipment.

The CSI-TRS-ResourceSetId represents CSI-TRS-ResourceSetId IE in the following Table 6. The CSI-TRS-ResourceSetId may be used to identify a single TRS resource set and have an identifier value according to the maximum number of TRS resource sets supported by NR maxNrofCSI-TRS-ResourceSets.

TABLE 6
CSI-TRS-ResourceSetId information element

-- ASN1START
-- TAG-CSI-TRS-RESOURCESETID-START
CSI-TRS-ResourceId information element
CSI-TRS-ResourceSetId ::= INTEGER
(0..maxNrofCSI-TRS-ResourceSets-1)
-- TAG-CSI-TRS-RESOURCESETID-STOP
-- ASN1STOP

According to one or more example embodiments, maxNrofCSI-TRS-ResourcePerSet and maxNrofCSI-TRS-ResourceSets may be additionally defined in multiplicity and type constraint definitions of RRC, as illustrated in the following Table 7.

TABLE 7
-- ASN1START
-- TAG-MULTIPLICITY-AND-TYPE-CONSTRAINT-DEFINITIONS-START
...
maxNrofCSI-TRS-ResourcePerSet INTEGER ::= 64 -- Maximum number of
CSIRS for Tracking resources in a resource set.
maxNrofCSI-TRS-ResourceSets INTEGER ::= 64 -- Maximum number of
CSIRS for Tracking resource sets per cell.
...
-- TAG-MULTIPLICITY-AND-TYPE-CONSTRAINT-DEFINITIONS-STOP
-- ASN1STOP

As illustrated in Table 7, the maxNrofCSI-TRS-ResourcePerSet represents the maximum number of CSI-RS resources for tracking in a resource set, and the maxNrofCSI-TRS-ResourceSets represents the maximum number of CSI-RS resource sets for tracking per cell. For example, the maximum number of TRS resources in a resource set is 64, and the number of TRS resource sets per cell is 64.

A list of resource sets of each reference signal may be configured through the higher-layer parameter CSI-MeasConfig. The CSI-MeasConfig may be used to configure CSI-RS belonging to the serving cell including CSI-MeasConfig, CSI reporting transmitted over the PUCCH of the serving cell, and CSI reporting transmitted over the PUSCH triggered by DCI received in the serving cell.

According to one or more example embodiments, the base station may be configured with CSI-MeasConfig to the user equipment, as illustrated in Table 8. The CSI-MeasConfig includes csi-TRS-ResourceSetToAddModList, indicating the pool of TRS resource sets referenced by CSI-ReportConfig, and csi-TRS-ResourceSetToReleaseList indicating the TRS resource sets to be released.

TABLE 8
CSI-MeasConfig information element

```
-- ASN1START
-- TAG-CSI-MEASCONFIG-START
CSI-MeasConfig ::= SEQUENCE {
...
  csi-SSB-ResourceSetToAddModList SEQUENCE (SIZE (1..maxNrofCSI-
SSB-ResourceSets)) OF CSI-SSB-ResourceSet OPTIONAL, -- Need N
  csi-SSB-ResourceSetToReleaseList SEQUENCE (SIZE (1..maxNrofCSI-
SSB-ResourceSets)) OF CSI-SSB-ResourceSetId OPTIONAL, -- Need N
  csi-TRS-ResourceSetToAddModList SEQUENCE (SIZE (1..maxNrofCSI-
TRS-ResourceSets)) OF CSI-TRS-ResourceSet OPTIONAL, -- Need N
  csi-TRS-ResourceSetToReleaseList SEQUENCE (SIZE (1..maxNrofCSI-
TRS-ResourceSets)) OF CSI-TRS-ResourceSetId OPTIONAL, -- Need N
...
-- TAG-CSI-MEASCONFIG-STOP
-- ASN1STOP
```

A TRS resource set list for channel estimation may be changed depending on csi-TRS-ResourceSetToAddModList and csi-TRS-ResourceSetToReleaseList in Table 8, and the resource setting may be configured based on the changed TRS resource set list.

Hereinafter, TRS-related procedures based on the above-described CSI-related higher-layer parameters will be described.

According to one or more example embodiments, the user equipment (UE) in RRC connection mode may be configured with an NZP-CSI-RS-ResourceSet with trs-Info set.

According to one or more example embodiments, the user equipment may not expect to be configured with a CSI-ReportConfig with the higher layer parameter reportQuantity set to other than ‘none,’ ‘trs-Index-RSRP,’ and ‘trs-Index-SINR’ for aperiodic NZP CSI-RS resource set configured with trs-Info.

According to one or more example embodiments, the user equipment may not expect to be configured with a CSI-ReportConfig with the higher layer parameter reportQuantity set to other than ‘none,’ ‘trs-Index-RSRP,’ and ‘trs-Index-SINR’ for periodic NZP CSI-RS resource set configured with trs-Info.

For example, the base station may configure CSI-ReportConfig with ‘trs-Index-RSRP’ and ‘trs-Index-SINR’ to the user equipment for both periodic and aperiodic TRS resource sets. If ReportQuantity is set to ‘trs-Index-RSRP’ for the TRS resource set, the user equipment may compute L1-RSRP based on the TRS resource set (for example, Table 5) configured by CSI-ResourceConfig (for example, Table 3).

According to another embodiment, if ReportQuantity is set to ‘trs-Index-SINR’ for the TRS resource set, the user equipment may compute L1-SINR based on the TRS resource set (for example, Table 5) configured by CSI-ResourceConfig (for example, Table 3).

Additionally, the user equipment may not expect to be configured with an NZP-CSI-RS-ResourSet in which both trs-Info and repetition are set.

If the user equipment is configured with a NZP-CSI-RS-ResourceSet configured with the higher layer parameter repetition set to ‘on,’ the user equipment may assume that at least one CSI-RS resources within the NZP-CSI-RS-ResourceSet are transmitted with the same downlink spatial domain transmission filter. For example, at least one CSI-RS resource within the NZP-CSI-RS-ResourceSet is transmitted through the same transmission beam. The at least one CSI-RS resource within the NZP-CSI-RS-ResourceSet may be transmitted through different OFDM symbols.

If repetition is set to ‘off’, the user equipment shall not assume that at least one CSI-RS resource within the NZP-CSI-RS-ResourceSet are transmitted with the same downlink spatial domain transmission filter. For example, the at least one CSI-RS resource within the NZP-CSI-RS-ResourceSet may be transmitted through different transmission beams.

If the user equipment is configured with a CSI-ReportConfig with reportQuantity set to “cri-RSRP,” “cri-SINR,” or “none” and if the CSI-ResourceConfig for channel measurement (higher layer parameter resourcesForChannelMeasurement) contains a NZP-CSI-RS-ResourceSet that is configured with the higher layer parameter repetition and without the higher layer parameter trs-Info, the user equipment may only be configured with the same number (1 or 2) of ports with the higher layer parameter nrofPorts for all CSI-RS resources within the set.

If the user equipment is configured with the CSI-RS resource in the same OFDM symbol(s) as an SS/PBCH block, the user equipment may assume that the CSI-RS and the SS/PBCH block are quasi co-located (QCLed) with ‘QCL-TypeD’ if ‘QCL-TypeD’ is applicable. Furthermore, the user equipment shall not expect to be configured with the CSI-RS in PRBs that overlap with those of the SS/PBCH block, and the user equipment shall expect that the same subcarrier spacing is used for both the CSI-RS and the SS/PBCH block.

According to one or more example embodiments, if the user equipment is configured with a CSI-ReportConfig with reportQuantity set to “trs-Index-RSRP” and “trs-Index-SINR,”the user equipment may only be configured with the CSI-ResourceConfig for a channel measurement (higher layer parameter resourcesForChannelMeasurement) that is configured with higher layer parameter csi-TRS-ResourceSetList. For example, if reportQuantity is set to “trs-Index-RSRP” and “trs-Index-SINR”, the user equipment may use the TRS resource set configured through CSI-ResourceConfig for channel measurement. In terms of resources, only csi-TRS-ResourceSetList may be allocated to the CSI-ResourceConfig for channel measurement (for example, if resourcesForChannelMeasurement is set).

Through the base station, it may be configured whether the CSI reported by the user equipment represents the entire frequency band or a specific frequency band. In an example case in which the CSI represents the entire frequency band, it is defined as wideband, and in an example case in which it represents a specific frequency band, it is defined as subband. Such a frequency-granularity may be configured through higher-layer parameters.

A CSI Reporting Setting is said to have a wideband frequency-granularity if:
reportQuantity is set to ‘cri-RI-PMI-CQI’, or ‘cri-RI-L1-PMI-CQI’, cqi-FormatIndicator is set to ‘widebandCQI’ and pmi-FormatIndicator is set to ‘widebandPMI,’ or
reportQuantity is set to ‘cri-RI-il,’ or
reportQuantity is set to ‘cri-RI-CQI’ or ‘cri-RI-il-CQI’ and cqi-FormatIndicator is set to ‘widebandCQI,’ or
reportQuantity is set to ‘cri-RSRP’ or ‘ssb-Index-RSRP’ or ‘cri-SINR’, or ‘ssb-Index-SINR’ or ‘trs-Index-RSRP’ or ‘trs-Index-SINR.’

In cases other than the above, the CSI reporting setting may be considered to have subband frequency-granularity. For example, according to one or more example embodiments, if reportQuantity is set to ‘trs-Index-RSRP’ or ‘trs-Index-SINR’, the CSI reporting setting may have wideband frequency-granularity.

The user equipment may not be expected to be configured with more than 64 NZP CSI-RS resources and/or SS/PBCH block resources in resource setting for channel measurement for a CSI-ReportConfig with the higher layer parameter reportQuantity set to ‘none,’ ‘cri-RI-CQI,’ ‘cri-RSRP,’ ‘ssb-Index-RSRP,’ ‘cri-SINR,’ ‘ssb-Index-SINR,’ or ‘trs-Index-RSRP’ or ‘trs-Index-SINR.’

For example, if reportQuantity is set to ‘trs-Index-RSRP’ or ‘trs-Index-SINR,’ the user equipment may be configured with up to 64 NZP CSI-RS resources and/or SS/PBCH block resources for channel measurement according to one or more example embodiments. In addition, the user equipment may be configured with up to 64 TRS resources for channel measurement according to one or more example embodiments.

According to one or more example embodiments, the user equipment may be configured with a CSI-ReportConfig with the higher layer parameter reportQuantity set to either ‘none,’ ‘cri-RI-PMI-CQI,’ ‘cri-RI-il,’ ‘cri-RI-il-CQI,’ ‘cri-RI-CQI,’ ‘cri-RSRP,’ ‘cri-SINR,’ ‘ssb-Index-RSRP,’ ‘ssb-Index-SINR,’ ‘cri-RI-L1-PMI-CQI,’ ‘trs-Index-RSRP,’ or ‘trs-Index-SINR.’

According to one or more example embodiments, if the user equipment is configured with a CSI-ReportConfig where reportQuantity is set to ‘cri-RSRP,’ ‘ssb-Index-RSRP,’ or ‘trs-Index-RSRP,’ the user equipment may operate according to the following cases 1.1 to 1.3.

1.1. If the user equipment is configured with the higher layer parameter groupBasedBeamReporting set to ‘disabled,’ the user equipment is not required to update measurements for more than 64 CSI-RS and/or SSB resources, and the user equipment shall report in a single report nrofReportedRS (higher layer configured) different CRI or SSBRI or TRSRI for each report setting. The higher-layer parameter nrofReportedRS indicates the number of reference signals to be reported for each reporting setting. The single reporting refers to a CSI report corresponding to a single reporting setting.

According to one or more example embodiments, the user equipment may be configured with groupBasedBeamReporting set to ‘disabled.’ In an example case in which TRSRI is reported, the user equipment may TRS resources measured for each report resetting to the single reporting.

1-2. If the user equipment is configured with the higher layer parameter groupBasedBeamReporting set to ‘enabled’, the user equipment is not required to update measurements for more than 64 CSI-RS and/or SSB resources, and the user equipment shall report in a single reporting instance two different CRI, two different SSBRI or two different TRSRI for each report setting, where CSI-RS and/or SSB resources can be received simultaneously by the user equipment either with a single spatial domain receive filter, or with multiple simultaneous spatial domain receive filters. For example, the user equipment may receive one or more reference signals through the single spatial domain receive filter or the multiple spatial domain receive filters, and report two different CRI, two different SSBRI or two different TRSRI to the base station based on the received reference signals.

1.3. If the user equipment is configured with the higher-layer parameter groupBasedBeamReporting-r17 (a group-based beam reporting parameter supported in Rel. 17), the user equipment is not required to update measurements for more than 64 CSI-RS, SSB, and/or TRS resources. If the higher-layer parameter nrofReportedGroups is configured, the user equipment shall report group(s) including two CRI, two SSBRI, or two TRSRI, each selecting one CSI-RS, SSB, or TRS from two CSI resource sets for each reporting setting, in a single report instance.

The group-based beam reporting is now described in detail. For both single-TRP (S-TRP) and multiple-TRP (M-TRP), the user equipment may report a combination of channel measurement resources (DL RS and/or DL beam), which may be simultaneously received from different TRPs, to the base station. If the higher-layer parameter groupBasedBeamReporting is set to ‘enabled,’ the user equipment according to one or more example embodiments may report two different CRI, two different SSBRI, and/or two different TRSRI to the base station for two CSI-RS, two SSB, and/or two TRS resources, which may be simultaneously received, through reporting setting.

According to one or more example embodiments, in an example case in which group-based beam reporting is supported, the user equipment may also report groups including two CRI, two SSBRI, or two TRSRI to the base station. For example, each group may include two CRI, two SSBRI, or two TRSRI.

If the user equipment is configured with a CSI-ReportConfig with the higher layer parameter reportQuantity set to ‘cri-SINR’ or ‘ssb-Index-SINR’ or ‘trs-Index-SINR,’ the user equipment may operate according to the following cases 2.1 and 2.2.

2.1. If the user equipment is configured with the higher layer parameter groupBasedBeamReporting set to ‘disabled,’ the user equipment shall report in a single report nrofReportedRSForSINR (higher layer configured) different CRI or SSBRI or TRSRI for each report setting.

2.2. If the user equipment is configured with the higher layer parameter groupBasedBeamReporting set to ‘enabled,’ the user equipment shall report in a single reporting instance two different CRI or SSBRI or TRSRI for each report setting, where CSI-RS and/or SSB resources may be received simultaneously by the UE.

If the user equipment is configured with a CSI-ReportConfig where reportQuantity is set to ‘ssb-Index-RSRP,’ the user equipment shall report SSBRIs. SSBRI k (where k≥0) corresponds to a (k+1)-th entry of the associated CSI-SSB-ResourceList within the corresponding CSI-SSB-ResourceSet.

According to one or more example embodiments, if the user equipment is configured with a CSI-ReportConfig with the higher layer parameter reportQuantity set to ‘ssb-IndexRSRP,’ the user equipment shall report SSBRI, where SSBRI k (k≥0) corresponds to the configured (k+1)-th entry of the associated csi-SSB-ResourceList in the corresponding CSI-SSB-ResourceSet.

For example, if the user equipment is configured with trs-Index-RSRP, the user equipment may report TRSRI for the (k+1)-th TRS resource set of the CSI-TRS-ResourceList to the base station. For TRSRI, similarly to SSBRI, additional CSI-TRS-ResourceSetList may be allocated from a currently allocated TRS resources to the base station, and the user equipment may select and report TRSRI based on the selected TRS resources.

If the user equipment is configured with a CSI-ReportConfig with the higher layer parameter reportQuantity set to ‘ssb-IndexSINR,’ the user equipment shall derive L1-SINR conditioned on the reported SSBRI, where SSBRI k (k≥0) corresponds to the configured (k+1)-th entry of the associated csi-SSB-ResourceList in the corresponding CSI-SSB-ResourceSet for channel measurement, and (k+1)-th entry of associated csi-IM-Resource in the corresponding csi-IM-ResourceSet or (k+1)-th entry of associated nzp-CSI-RSResource in the corresponding nzp-CSI-RS-ResourceSet for interference measurement.

According to one or more example embodiments, if the user equipment is configured with a CSI-ReportConfig where reportQuantity is set to ‘trs-Index-SINR,’ the user equipment shall derive L1-SINR conditioned on the reported TRSRI, where TRSRI k (k≥0) corresponds to the configured (k+1)-th entry of the corresponding CSI-TRS-ResourceList within the respective CSI-TRS-ResourceSet.

For example, if the user equipment is configured with trs-Index-SINR, the user equipment may compute L1-SINR based on the TRSRI of the (k+1)-th TRS resource set of the CSI-TRS-ResourceList and report the computed L1-SINR to the base station.

According to an embodiment, if the user equipment successfully decodes DCI format 0_1 or DCI format 0_2, which triggers a non-periodic CSI trigger state, the user equipment may perform non-periodic CSI reporting to a serving cell using PUSCH. The non-periodic CSI reporting performed on PUSCH may support wideband and subband frequency-granularity.

According to another embodiment, if the user equipment successfully decodes DCI format 0_1 or DCI format 0_2, which activates a semi-persistent CSI trigger state, the user equipment may perform semi-persistent CSI reporting on PUSCH.

The CSI reporting on PUSCH may have Type I and Type II. The CSI reporting may include two parts. The first part has a fixed payload size and is used to identify the number of information bits in the second part. The first part may be entirely transmitted before the second part.

However, according to one or more example embodiments, in an example case in which the higher layer parameter reportQuantity is configured with one of the values ‘cri-RSRP,’ ‘ssb-Index-RSRP,’ ‘criSINR,’ ‘ssb-Index-SINR,’ ‘trs-Index-RSRP,’ or ‘trs-Index-SINR,’ a CSI feedback may consist of a single part.

The user equipment may report CSI through UCI on PUCCH. If CSI is reported through PUCCH, the bitwidth for CRI, SSBRI, TRSRI, RSRP, and differential RSRP according to one or more example embodiments are as provided in Table 9.

TABLE 9

| Field | Bitwidth |
|---|---|
| CRI | $⌈ {log}_{2} ( {K}_{s}^{CSI - RS} ) ⌉$ |
| SSBRI | $⌈ {log}_{2} ( {K}_{s}^{SSB} ) ⌉$ |
| TRSRI | $⌈ {log}_{2} ( {K}_{s}^{TRS} ) ⌉$ |
| RSRP | 7 |
| Differential RSRP | 4 |

Referring to Table 9,

$${K}_{s}^{CSI - RS}$$

is the number of CSI-RS resources in the corresponding resource set, and

$${K}_{s}^{SSB}$$

is the configured number of SS/PBCH blocks in the corresponding resource set for reporting ‘ssb-Index-RSRP,’ and

$${K}_{s}^{TRS}$$

is the configured number of TRS in the corresponding resource set for report ‘trs-Index-RSRP.’ For example, for CRI, SSBRI, and TRSRI, the bitwidth may be determined by the number of resources in the resource set for RSRP reporting. The bitwidth for RSRP may be fixed at 7, and the bitwidth for differential RSRP may be fixed at 4.

According to one or more example embodiments, the bitwidth for CRI, SSBRI, SINR, and differential SINR are provided in Table 10.

TABLE 10

| Field | Bitwidth |
|---|---|
| CRI | $⌈ {log}_{2} ( {K}_{s}^{CSI - RS} ) ⌉$ |
| SSBRI | $⌈ {log}_{2} ( {K}_{s}^{SSB} ) ⌉$ |
| TRSRI | $⌈ {log}_{2} ( {K}_{s}^{TRS} ) ⌉$ |
| SINR | 7 |
| Differential SINR | 4 |

Referring to Table 10,

$${K}_{s}^{CSI - RS}$$

is the number of CSI-RS resources in the corresponding resource set, and

$${K}_{s}^{SSB}$$

is the configured number of SS/PBCH blocks in the corresponding resource set for reporting ‘ssb-Index-SINR,’ and

$${K}_{s}^{TRS}$$

is the configured number of TRS in the corresponding resource set for report ‘trs-Index-SIRN.’ For example, for CRI, SSBRI, and TRSRI, the bitwidth may be determined by the number of resources in the resource set for SINR reporting. The bitwidth for RSRP may be fixed at 7, and the bitwidth for differential RSRP may be fixed at 4.

For example, if the number of beams is set to the maximum of 64 and TRS is used for channel measurement, the number of TRS resources for RSRP or SINR reporting is 64. Therefore, a total of 6 bits are required for TRSRI.

According to the above-described embodiments, the bitwidth of TRSRI may be ultimately determined based on the number of TRS resources in the TRS resource set for reporting RSRP or SINR.

In an example case in which the user equipment transmits a single CSI report to the base station, CSIs may have a mapping order within the CSI report.

According to one or more example embodiments, the mapping order of the single CSI report for CRI/RSRP, SSBRI/RSRP, or TRSRI/RSRP reporting is provided in Table 11.

TABLE 11

| CSI report | |
|---|---|
| Number | CSI fields |
| CSI report | CRI or SSBRI or TRSRI #1 if reported |
| #n | CRI or SSBRI or TRSRI #2 if reported |
| | CRI or SSBRI or TRSRI #3 if reported |
| | CRI or SSBRI or TRSRI #4 if reported |
| | RSRP #1 if reported |
| | Differential RSRP #2 if reported |
| | Differential RSRP #3 if reported |
| | Differential RSRP #4 if reported |

According to Table 11, a single CSI report for RSRP may include one or more combinations of CRI/SSBRI/TRSRI, RSRP, and differential RSRP.

According to one or more example embodiments, the mapping order of the single CSI report for CRI/SINR, SSBRI/SINR, or TRSRI/SINR reporting is provided in Table 12.

TABLE 12

| CSI report | |
|---|---|
| Number | CSI fields |
| CSI report # | CRI or SSBRI or TRSRI #1 if reported |
| n | CRI or SSBRI or TRSRI #2 if reported |
| | CRI or SSBRI or TRSRI #3 if reported |
| | CRI or SSBRI or TRSRI #4 if reported |
| | SINR #1 if reported |
| | Differential SINR #2 if reported |
| | Differential SINR #3 if reported |
| | Differential SINR #4 if reported |

According to Table 12, a single CSI report for SINR may include one or more combinations of CRI/SSBRI/TRSRI, SINR, and differential SINR.

According to one or more example embodiments, the mapping order of one CSI report for group-based CRI/RSRP, SSBRI/RSRP, or TRS/RSRP is provided in Table 13.

TABLE 13

| CSI | |
|---|---|
| report | |
| number | CSI fields |
| CSI | Resource set indicator |
| report | CRI or SSBRI or TRSRI #1 of 1st resource group if reported |
| #n | CRI or SSBRI or TRSRI #2 of 1st resource group if reported |
| | CRI or SSBRI or TRSRI #1 of 2nd resource group if reported |
| | CRI or SSBRI or TRSRI #2 of 2nd resource group if reported |
| | CRI or SSBRI or TRSRI #1 of 3rd resource group if reported |
| | CRI or SSBRI or TRSRI #2 of 3rd resource group if reported |
| | CRI or SSBRI or TRSRI #1 of 4th resource group if reported |
| | CRI or SSBRI or TRSRI #2 of 4th resource group if reported |
| | RSRP of CRI or SSBRI or TRSRI #1 of 1st resource group |
| | Differential RSRP of CRI or SSBRI or TRSRI #2 of 1st |
| | resource group |
| | Differential RSRP of CRI or SSBRI or TRSRI #1 of 2nd |
| | resource group if reported |
| | Differential RSRP of CRI or SSBRI or TRSRI #2 of 2nd |
| | resource group if reported |
| | Differential RSRP of CRI or SSBRI or TRSRI #1 of 3rd |
| | resource group if reported |
| | Differential RSRP of CRI or SSBRI or TRSRI #2 of 3rd |
| | resource group if reported |
| | Differential RSRP of CRI or SSBRI or TRSRI #1 of 4th |
| | resource group if reported |
| | Differential RSRP of CRI or SSBRI or TRSRI #2 of 4th |
| | resource group if reported |

According to Table 13, group-based CSI reporting may include one or more combinations of CRI/SSBRI/TRSRI, RSRP, and differential RSRP for a specific order of resource groups.

Hereinafter, example embodiments related to TRS-based CSI measurement and reporting according to the above-described embodiments will be described.

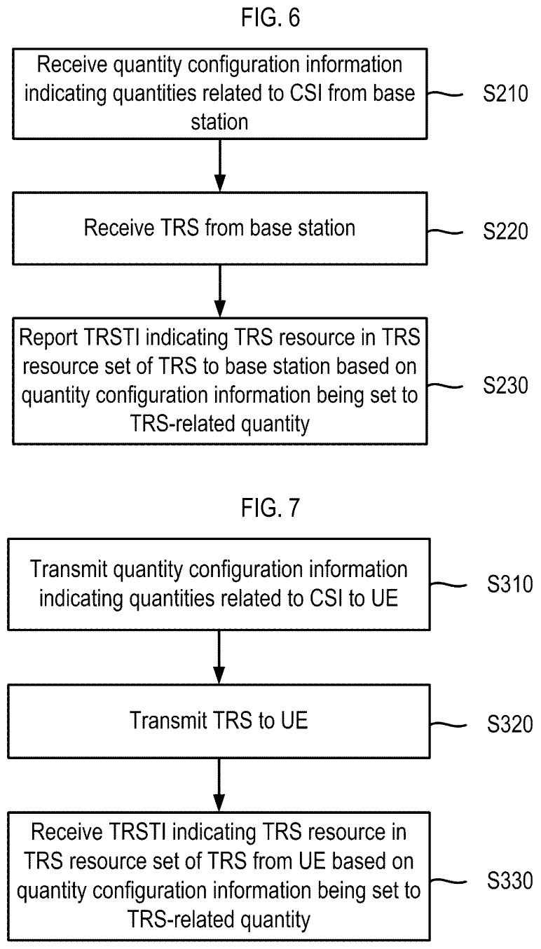

FIG. 6 is a flowchart illustrating a method of user equipment according to one or more example embodiments.

Referring to FIG. 6, in operation S210, the user equipment may receive quantity configuration information from a base station. For example, the quantity configuration information may indicate CSI-related quantities. The user equipment may be configured with the quantity configuration information through RRC signaling. For example, the quantity configuration information may be a higher layer parameter reportQuantity. reportQuantity may be included in CSI-ReportConfig of Table 2. For example, the base station may transmit CSI-ReportConfig, including reportQuantity indicating CSI quantity, to the user equipment.

According to one or more example embodiments, the quantity configuration information may include TRS-related quantity. The TRS-related quantity is related to RSRP and SINR and may be one of, for example, the above-mentioned trs-Index-RSRP and trs-Index-SINR.

In operation S220, the user equipment may receive TRS from the base station. For example, TRS may be mapped onto the resource grid as illustrated in FIG. 4. For example, the user equipment may receive TRS from the mapped resource. In FR1, the user equipment may receive TRS in two consecutive slots. In FR2, the user equipment may receive TRS in a single slot.

In operation S230, the user equipment may report TRSRI indicating a TRS resource within the TRS resource set of the TRS to the base station, based on the quantity configuration information received in operation S210 being set to a TRS-related quantity. For example, the user equipment may obtain TRSRI indicating a TRS resource within the TRS resource set of the TRS based on the quantity configuration information, and report the TRSRI to the base station. In an example case in which when reportQuantity is set to trs-Index-RSRP or trs-Index-SINR, the user equipment may report TRSRI to the base station.

TRSRI may indicate a candidate TRS among the TRS resources included in the TRS resource set for which the user equipment has computed RSRP or SINR. For example, TRSRI may correspond to a (k+1)-th entry (where k is an integer greater than or equal to 0) in TRS resource list information.

The user equipment may estimate measurement parameters (for example, RSRP and SINR) from TRS corresponding to TRSRI and report the estimated measurement parameters along with TRSRI to the base station. For example, the TRSRI and measurement parameter may be transmitted through PUCCH or PUSCH.

For example, the maximum number of TRS resource sets corresponding to the TRS resource indicated by TRSRI may be set to 64, and the maximum number of TRS resources in the TRS resource set may be set to 64.

According to the above-described embodiments, in addition to CSI-RS and SS/PBCH blocks, TRS may be used for channel and signal quality estimation. CSI-RS and SS/PBCH may not be allocated based on the operation of primary cell (PCell)/secondary cell (SCell). In an example case in which TRS is used for channel estimation according to example embodiment, the user equipment may perform channel estimation and reporting using TRS even in a cell to which CSI-RS and SS/PBCH are not allocated.

In addition, compared to SS/PBCH, more resources are allocated to TRS over a wider bandwidth. Therefore, the user equipment may estimate and report measurement parameters, more appropriate to an actual channel, using the TRS.

FIG. 7 is a flowchart illustrating a method of a base station according to one or more example embodiments.

Referring to FIG. 7, in operation S310, the base station may transmit quantity configuration information. For example, the quantity configuration information may indicate indicating CSI-related quantities to the user equipment. The base station may configure CSI-ReportConfig, including reportQuantity, to the user equipment through RRC signaling.

In operation S320, the base station may transmit TRS to the device. Each TRS resource may correspond to each of a plurality of transmission beams sent by the base station.

In operation S330, the base station may receive TRSRI, indicating a TRS resource within a TRS resource set of the TRS, from the user equipment based on the quantity configuration information being set to TRS-related quantity. For example, the base station may configure the user equipment with reportQuantity set to trs-Index-RSRP or trs-Index-SINR and receive TRSRI and measurement parameters according to the corresponding quantity (for example, RSRP or SINR) from the user equipment. The base station may check a channel or perform transmission beam switching based on the received TRSRI and measurement parameters.

According to the above-described embodiments, the base station may receive and check channel estimation parameters based on TRS even in the operation of a cell without allocated CSI-RS and SS/PBCH. Accordingly, the base station may more efficiently use and allocate DL resources based on the received estimated parameters.

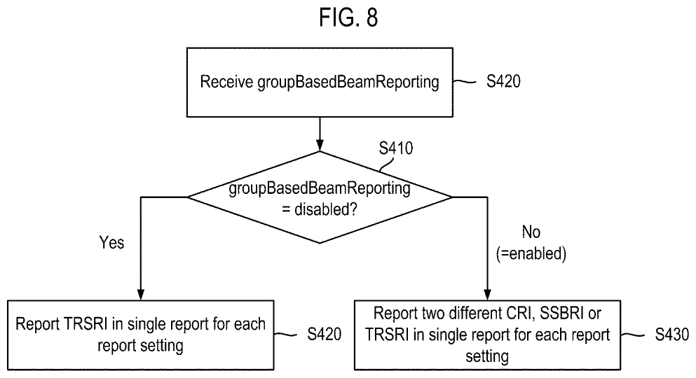

FIG. 8 is a flowchart illustrating a reporting method of user equipment according to one or more example embodiments.

Referring to FIG. 8, in operation S410, the user equipment may receive group beam reporting configuration information from the base station. The group beam reporting configuration information may be the groupBasedBeamReporting. groupBasedBeamReporting may be set to ‘disabled’ or ‘enabled’ to set whether group-based beam reporting is enabled.

In operation S420, the user equipment may check the received group beam reporting configuration information.

In an example case in which the quantity configuration information is set to the TRS-related quantity and the group beam reporting configuration information is set to ‘disabled,’ the flow proceeds to operation S430 in which the equipment may report TRSRI for each reporting setting in a single report.

In an example case in which the quantity configuration information is set to the TRS-related quantity and the group beam reporting configuration information is set to ‘enabled,’ the flow proceeds to operation S440 in which the user equipment may report two different CRI and SSBRI, or the TRSRI to the base station in a single report.

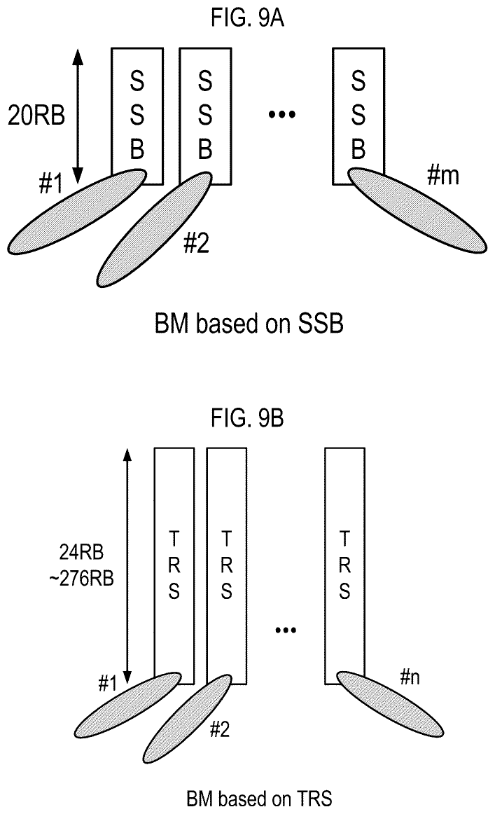

FIGS. 9A and 9B are diagrams illustrating a downlink (DL) beam management (BM) operation according to one or more example embodiments. FIG. 9A illustrates a DL beam management operation based on SSB and FIG. 9B illustrates a DL beam management operation based on TRS.

Referring to FIG. 9A, in an example case in which a DL beam is selected based on SSB, user equipment may receive SSB from a base station. The user equipment may receive SSBs mapped to up to 64 different beams from the base station at each specific period. SSB may have a bandwidth of 20 RBs.

Each SSB may have an index #1 to #m and be mapped to a beam. The user equipment may receive SSBs and measure measurement parameters (for example, RSRP or SINR) from the received SSBs. The user equipment may select the beam mapped to SSB having the best measurement parameter as a candidate beam and report an index of SSBRI, the SSB corresponding to the beam, and the measurement parameter to the base station.

Referring to FIG. 9B, in an example case in which a DL beam is selected based on TRS according to one or more example embodiments, the user equipment may receive TRS from the base station. TRS may be transmitted at a specific period in one or two consecutive slots according to FR (FR1 or FR2). Also, TRS may have a bandwidth of at least 24 RBs and up to 276 RBs.

Each TRS may have an index #1 to #n and be mapped to a beam. The user equipment may receive TRSs and measure measurement parameters (for example, RSRP or SINR) from the received TRSs. The user equipment may select the beam mapped to the TRS having the best measurement parameter as a candidate beam and report an index of TRSRI, the TRS corresponding to the beam, and the measurement parameter to the base station.

Since TRS has a wider bandwidth than SSB, TRS may be more appropriate to an actual channel than SSB. Therefore, in an example case in which TRS-based beam management may be performed according to one or more example embodiments, a candidate beam more appropriate to the actual channel may be selected.

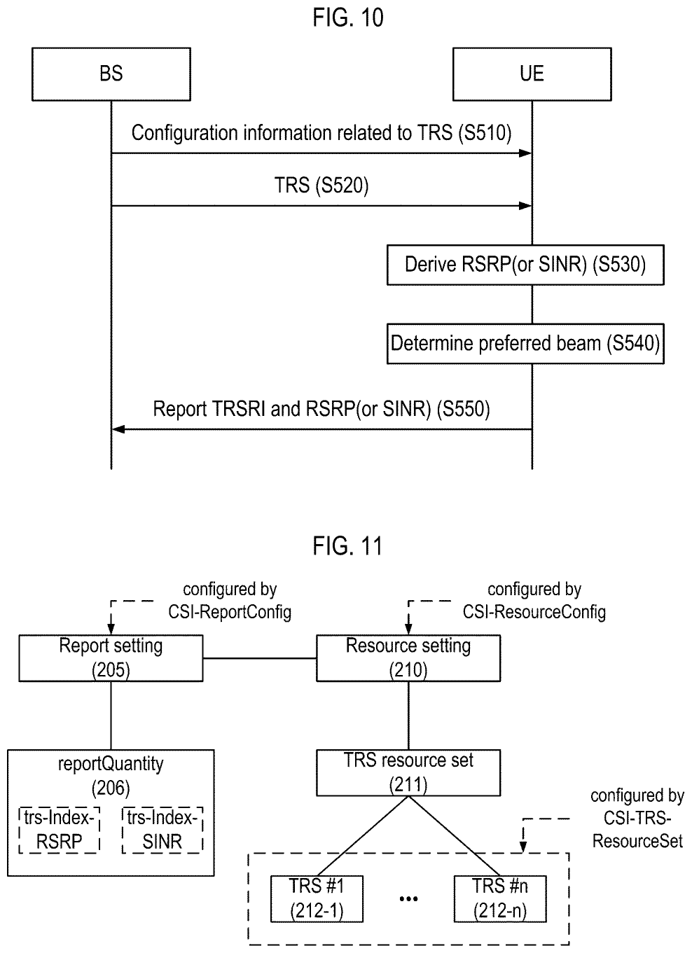

FIG. 10 is a flowchart illustrating a procedure related to DL beam management according to one or more example embodiments.

Referring to FIG. 10, in operation S510, a base station may transmit TRS-related configuration information to user equipment. For example, the TRS-related configuration information may include CSI-ReportConfig, which is used to configure settings such as reportQuantity indicating trs-Index-RSRP or trs-Index-SINR, resourcesForChannelMeasurement indicating resource settings for channel measurement, reporting type, and group-based beam reporting, CSI-ResourceConfig referenced by CSI-ReportConfig (for example, referenced through CSI-ResourceConfigId), and CSI-TRS-ResourceSet for configuring TRS resource sets.

CSI-ResourceConfig may include a list of TRS resource sets among CSI-RS resource sets, as resource configuration information.

CSI-TRS-ResourceSet may include a list of TRS resources within the TRS resource set, as resource set configuration information. For example, TRS resource sets for channel estimation may be configured to the user equipment through CSI-ResourceConfig, and TRS resources within each TRS resource set may be configured to the user equipment through CSI-TRS-ResourceSet.

In operation S520, the base station may transmit TRS to the user equipment in the TRS resources.

In operation S530, the user equipment may derive RSRP based on reportQuantity being set to trs-Index-RSRP. According to another embodiment, the user equipment may derive SINR based on reportQuantity being set to trs-Index-SINR. The device may derive SINR based on the reported TRSRI.

In operation S540, the user equipment may determine the candidate beam based on the derived RSRP (or SINR).

In operation S550, the user equipment may report RSRP (or SINR) along with TRSRI corresponding to the candidate beam to the base station.

FIG. 11 is a diagram illustrating a CSI framework according to one or more example embodiments.

Referring to FIG. 11, the CSI framework using TRS for CSI reporting may include a reporting setting 205 and a resource setting 210. For brevity of the drawing, only one reporting setting 205 and only one resource setting 210 are illustrated, but the user equipment may be configured with a plurality of reporting settings 205 and a plurality of resource settings 210.

The reporting setting 205 may be configured through CSI-ReportConfig in Table 2. Each reporting setting 205 may include reportQuantity 206, and reportQuantity 206 according to an example embodiment may indicate trs-Index-RSRP or trs-Index-SINR. In an example case in which reportQuantity 206 indicates trs-Index-RSRP or trs-Index-SINR as a CSI quantity, the user equipment configured with the corresponding CSI quantity may obtain RSRP or SINR using TRS and report the computed RSRP or SINR and TRSRI to the base station. For example, the user equipment may compute RSRP or SINR based on the TRS.

In addition, the resource setting 210 corresponding to the higher-layer parameter resourcesForChannelMeasurement configured in the reporting setting 205 and having CSI-ResourceConfigId corresponding to resources ForChannelMeasurement may be used for channel estimation. For example, the reporting setting 205 may reference the resource setting 210 through an identifier.

The resource setting 210, referenced from the reporting setting 205 for which channel estimation is configured, may set a resource for channel estimation. The resource setting 210 may be configured through CSI-ResourceConfig in Table 3. Each resource setting 210 may include csi-TRS-ResourceSetList, and csi-TRS-ResourceSetList may define TRS resource sets for channel estimation.

A single TRS resource set 211 may include a plurality of TRS resources 212-1 to 412-n. The plurality of TRS resources 212-1 to 412-n may be configured through CSI-TRS-ResourceSet in Table 5. The plurality of TRS resources 212-1 to 412-n may have indices, and TRS resources corresponding to the candidate beam, among the plurality of TRS resources 212-1 to 412-n, may be reported to the base station through TRSRI.

Next, a description will be provided for L1-RSRP and L1-SINR reporting from user equipment, as well as the operation S450 of FIG. 10, according to the above-described embodiments.

In an example case in which resource-wise QCL is applied to ‘QCL-TypeC’ and, if applicable, ‘QCL-TypeD,’ CSI-RS, SS/PBCH, and/or TRS resources may be configured for the user equipment to compute L1-RSRP. The user equipment may be configured with CSI-RS resource settings for up to 16 CSI-RS resource sets, where each CSI-RS resource set may have up to 64 resources. The total number of different CSI-RS resources across all resource sets may not be greater than 128. Similarly, each TRS resource set may have up to 64 resources.

In the case of L1-RSRP reporting, based on the higher-layer parameter nrofReportedRS for the number of reference signals reported in CSI-ReportConfig being set to 1, the reported L1-RSRP value may be defined as a 7-bit value and may have a value of 1 dB in the range of [−140, −44] dBm.

In an example case in which the higher-layer parameter nrofReportedRS for the number of reported RSs is set to a value greater than 1, or in an example case in which the higher-layer parameter groupBasedBeamReporting for group-based beam reporting is set to ‘enabled,’ the user equipment may use differential L1-RSRP-based reporting. A largest measured value of L1-RSRP may be defined as a 7-bit value and may have a value of 1 dB in the range of [−140, −44] dBm, and the differential L1-RSRP may be defined as a 4-bit value. The differential L1-RSRP value may have a value of 2 dB with respect to the largest measured L1-RSRP value, which may correspond to a portion of the same L1-RSRP reporting instance. Mapping between the reported L1-RSRP value and the measured quantity may be additionally defined.

For L1-SINR computation, NZP CSI-RS, SS/PBCH, and/or TRS may be configured for the user equipment for channel measurement, and NZP CSI-RS or CSI-IM may be configured for the user equipment for interference measurement. For channel measurement, the user equipment may be configured with CSI-RS resource settings for up to 16 resource sets having up to 64 CSI-RS resources, or up to 64 SS/PBCH block resources. The total number of different CSI-RS resources across all resource sets may not be greater than 128. Similarly, each TRS resource set may have up to 64 resources.

For L1-SINR reporting, based on the higher-layer parameter nrofReportedRSForSINR for the number of reference signals reported for SINR in CSI-ReportConfig being set to 1, the reported L1-SINR value may be defined as a 7-bit value and may have a value of 0.5 dB in the range of [−23, 40] dB. In an example case in which the higher-layer parameter nrofReportedRSForSINR for the number of reported RSs is set to a value greater than 1, or in an example case in which the higher-layer parameter groupBasedBeamReporting for group-based beam reporting is ‘enabled,’ the user equipment may use differential L1-SINR-based reporting. A largest measured value of L1-SINR may be defined as a 7-bit value and have a value of 0.5 dB in the range of [−23, 40] dB, and the differential L1-SINR may be defined as a 4-bit value. The differential L1-SINR value may be a value of 1 dB with respect to the largest measured L1-SINR value, which may correspond to a portion of the same L1-SINR reporting instance. Mapping between the reported L1-RSRP value and the measured value may be additionally defined.

In an example case in which NZP CSI-RS is configured for channel measurement and/or interference measurement, the reported L1-SINR value may be defined so as not to be compensated for by power offset(s) given by a higher-layer parameter (powerControlOffsetSS or powerControlOffset) for power control.

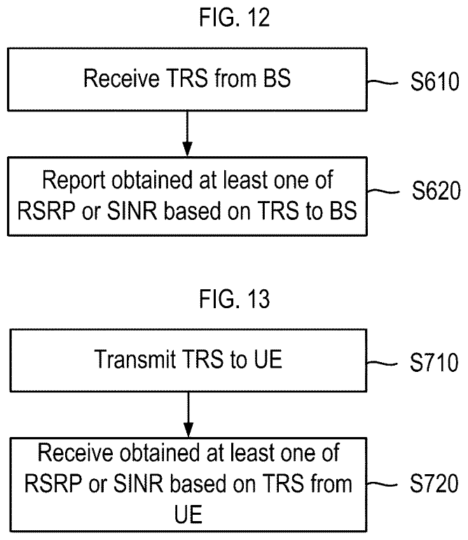

FIG. 12 is a flowchart illustrating a method of operating a device according to one or more example embodiments.

Referring to FIG. 12, in operation S610, the device may receive TRS from a base station. In operation S620, the device may report at least one of RSRP or SINR, obtained based on the TRS, to the base station.

According to the above-described embodiments, TRS for tracking may be used for RSRP and/or SINR measurement and reporting, so that the device may report RSRP and/or SINR more appropriate to an actual channel to the base station. The RSRP and/or SINR may include at least one of RSRP or SINR. For example, only RSRP may be reported, only SINR may be reported, or both RSRP and SINR may be reported.

FIG. 13 is a flowchart illustrating a method of operating a device according to one or more example embodiments.

Referring to FIG. 13, in operation S710, the device may transmit TRS to the device. In operation S720, the device may receive at least one of RSRP and SINR obtained based on the TRS from the device.

According to the above-described embodiments, the device may use the RSRP and/or SINR measured from the TRS for tracking, so that RSRP and/or SINR more appropriate to an actual channel may be used through the base station.

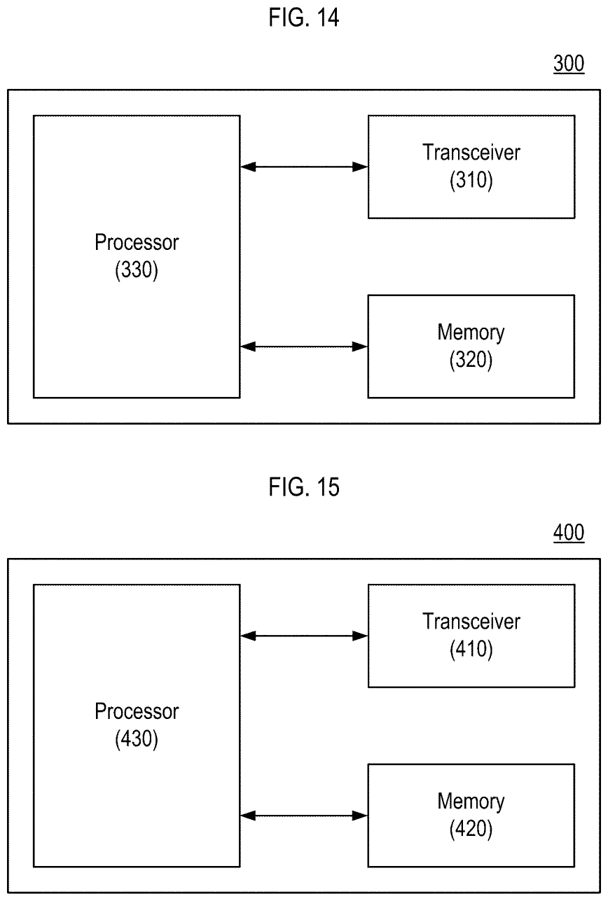

FIG. 14 is a block diagram of a device according to one or more example embodiments. For example, the device may be a base station.

Referring to FIG. 14, a device 300 may include a transceiver 310, a memory 320, and a processor 330. However, components of the device 300 are not limited to the above-mentioned examples. For example, the device 300 may include more components or fewer components than the above-mentioned components. In addition, at least a portion or all of the transceiver 310, the memory 320, and the processor 330 may be implemented as a single chip.

In example embodiments, the transceiver 310 may transmit signals to a base station and may receive signals from the base station. The transmitted signals and the received signal may include control information and data. According to one or more example embodiments, the transceiver 310 may transmit a reference signal (for example, TRS) for channel estimation to the user equipment under the control of the processor 330, and receive CSI-related information from the user equipment.

According to one or more example embodiments, the transceiver 310 may include a radio-frequency (RF) transmitter and an RF receiver. The RF transmitter may be configured to up-convert and/or amplify a frequency of a transmitted signal, and the RF receiver may be configured to amplify a received signal with low noise and/or down-convert a frequency of the received signal. In addition, the transceiver 310 may receive a signal through a wireless channel and output the received signal to the processor 330, and transmit a signal, output from the processor 330, through a wireless channel.

The memory 320 may be provided in singular or plural and connected to the processor 330, and may store various types of information related to the operation of the processor 330. For example, the memory 320 may store software code including at least one instruction for performing a portion or all of the processes controlled by the processor 330 or for performing at least one instruction of the descriptions, functions, procedures, proposals, methods, and/or operation flowcharts related to the base station according to one or more example embodiments.

The processor 330 may be provided in singular or plural to control the memory 320, and may execute at least one instruction, stored in the memory, to implement the descriptions, functions, procedures, proposals, methods, and/or operation flowcharts related to the base station according to one or more example embodiments. In addition, the processor 330 may provide various operations according to various embodiments based on the instructions stored in the memory 320. In addition, the processor 330 may process information stored in the memory 320 to generate data.

According to one or more example embodiments, the processor 330 may execute at least one instruction to transmit TRS to the user equipment through the transceiver 410 and receive at least one of RSRP or SINR, obtained based on the TRS, from the user equipment.

According to one or more example embodiments, the device 300 may execute at least one instruction in the processor 330 to transmit quantity setting information indicating CSI-related quantities to the user equipment through the transceiver 310, transmit TRS to the user equipment through the transceiver 310, and receive TRSRI indicating a TRS resource within the TRS resource set of the TRS from the user equipment through the transceiver 310 based on the quantity configuration information being set to a TRS-related quantity.

According to an embodiment, the device 300 may allow the user equipment to use TRS for channel estimation, thereby performing channel estimation even in an example case in which CSI-RS or SSB is not allocated to a cell, and selecting a candidate beam based on the channel estimation. Compared to channel estimation based on SSB transmitted in a relatively narrow bandwidth, channel estimation based on TRS may be more appropriate to actual channel estimation.

In addition, the device 300 may select a candidate beam using TRS even in PCell/SCell to which CSI-RS or SSB is not allocated.

FIG. 15 is a block diagram of a device according to one or more example embodiments. The device may be, for example, a user equipment connected to a base station. Hereinafter, detailed descriptions overlapping with FIG. 12 will be omitted.

Referring to FIG. 15, a device 400 may include a transceiver 410, a memory 420, and a processor 430.

In example embodiments, the transceiver 410 may transmit signals to a base station and may receive signals from the base station. The transmitted signal and the received signal may include control information and data. According to one or more example embodiments, the transceiver 410 may receive a reference signal (for example, TRS) for channel estimation from the base station under the control of the processor 430, and report CSI-related information to the base station.

The memory 420 may be provided in singular or plural and connected to the processor 430, and may store software code including at least one instruction for performing at least one instruction of the descriptions, functions, procedures, proposals, methods, and/or operation flowcharts related to the equipment according to one or more example embodiments.

The processor 430 may be provided in one or more, control the memory 420, and may be configured to implement the descriptions, functions, procedures, proposals, methods, and/or operation flowcharts related to the device of the disclosure by executing at least one instruction stored in the memory 420. In addition, the processor 430 may provide various operations according to various embodiments based on the instructions stored in the memory 420.

According to one or more example embodiments, the processor 430 may execute at least one instruction to receive TRS from the base station through the transceiver 410 and report at least one of RSRP or SINR, obtained based on the received TRS, to the base station.

According to one or more example embodiments, the processor 430 may execute at least one instruction to receive quantity configuration information indicating CSI-related quantities from the base station through the transceiver 410, receive TRS from the base station through the transceiver 410, and report TRSRI indicating a TRS resource within the TRS resource set of the TRS to the base station through the transceiver 410 based on the quantity configuration information being set to a TRS-related quantity.

The device 400 according to the above-described embodiments may perform channel estimation and select a candidate beam based on the channel estimation using the TRS received from the base station for channel estimation, even in an example case in which CSI-RS or SSB is not allocated to a cell. Compared to channel estimation based on SSB transmitted in a relatively narrow bandwidth, the channel estimation based on TRS may be more appropriate to actual channel estimation.

As set forth above, according to one or more example embodiments, CSI reporting method and device in a wireless communication system using a tracking reference signal (TRS) may be provided.

While example embodiments have been shown and described above, it will be apparent to those skilled in the art that modifications and variations could be made without departing from the scope of the inventive concept as defined by the appended claims.

What is claimed is:

1. A method performed by a user equipment in a wireless communication system, the method comprising:
receiving a tracking reference signal (TRS) from a base station; and
reporting, to the base station, at least one of reference signal received power (RSRP) and signal-to-interference-plus-noise ratio (SINR), obtained based on the TRS.

2. The method of claim 1, further comprising:
receiving, from the base station, quantity configuration information indicating quantities related to channel state information (CSI); and
reporting, to the base station, a TRS resource indicator (TRSRI) indicating TRS resources within TRS resource sets of the TRS based on the quantity configuration information.

3. The method of claim 2, further comprising:
receiving, from the base station, resource configuration information comprising list information of the TRS resource sets among CSI-reference signal (CSI-RS) resource sets.

4. The method of claim 2, further comprising:
receiving, from the base station, resource set configuration information comprising list information of the TRS resources within the TRS resource sets.

5. The method of claim 2, wherein a maximum number of the TRS resource sets is set to 64, and a maximum number of the TRS resources within the TRS resource sets is set to 64.

6. The method of claim 2, further comprising:
receiving group beam reporting configuration information from the base station; and
reporting the TRSRI in a single report for each report setting, based on the quantity configuration information being set to a TRS-related quantity and the group beam reporting configuration information being set to ‘disabled.’

7. The method of claim 6, further comprising:
reporting two different CSI-RS resource indicator (CRI) and SS/PBCH block resource indicator (SSBRI) or the TRSRI in the single report, based on the quantity configuration information being set to the TRS-related quantity and the group beam reporting configuration information being set to ‘enabled.’

8. The method of claim 4, wherein
the TRSRI corresponds to a (k+1)-th entry in the list information of the TRS resources (where k is an integer greater than or equal to 0).

9. The method of claim 2, further comprising:
deriving the SINR based on the TRSRI.

10. The method of claim 2, further comprising:
measuring at least one of the RSRP and the SINR based on the TRS.

11. The method of claim 2, wherein the TRSRI has a bitwidth determined based on a number of the TRS resources within the TRS resource sets for reporting the RSRP or the SINR.

12. The method of claim 3, wherein the list information of the TRS resource sets defines TRS resources used for beam measurement and reporting.

13. A method performed by a base station in a wireless communication system, the method comprising:
transmitting a tracking reference signal (TRS) to a user equipment; and
receiving, from the user equipment, at least one of reference signals received power (RSRP) and signal-to-interference-plus-noise ratio (SINR) obtained based on the TRS.

14. The method of claim 13, further comprising:
transmitting, to the user equipment, quantity configuration information indicating quantities related to channel state information (CSI); and
receiving, from the user equipment, a TRS resource indicator (TRSRI) indicating TRS resources within TRS resource sets of the TRS based on the quantity configuration information.

15. The method of claim 14, further comprising:
transmitting, to the user equipment, resource configuration information comprising list information of the TRS resource sets among CSI-reference signal (CSI-RS) resource sets.

16. The method of claim 14 further comprising:
transmitting, to the user equipment, resource set configuration information comprising list information of the TRS resources within the TRS resource sets.

17. The method of claim 14, wherein a maximum number of the TRS resource sets is set to 64, and a maximum number of the TRS resources within the TRS resource sets is set to 64.

18. The method of claim 16, wherein the TRSRI corresponds to a (k+1)-th entry in the list information of the TRS resources (where k is an integer greater than or equal to 0).

19. The method of claim 14, wherein the TRSRI has a bitwidth determined based on a number of the TRS resources within the TRS resource sets for reporting the RSRP or the SINR.

20. A wireless communication system comprising:
one or more transceivers;
one or more processors electrically connected to the one or more transceivers; and
one or more memories electrically connected to the one or more processors and configured to store at least one instruction,
wherein, when executed by the at least one processor, the at least one instruction is configured to control the device to:
receive a tracking reference signal (TRS) from a base station through the transceiver; and
report, to the base station, at least one of reference signals received power (RSRP) and signal-to-interference-plus-noise ratio (SINR) obtained based on the TRS.
